(19) United States
(12) Patent Application Publication
(10) Pub. No.: US 2002/0152394 A1
(43) Pub. Date: Oct. 17, 2002

(54) Control method for program and data, and computer

(76) Inventor: Yuichi Kadoya, Tokyo (JP)

Correspondence Address: Brinks Hofer Gilson & Lione, P.O. Box 10395, Chicago, IL, 60610, US

(21) Appl. No.: 10/106,700

(22) Filed: Mar. 25, 2002

(30) Foreign Application Priority Data
Apr. 16, 2001 (JP) JP2001-116516
Jul. 17, 2001 (JP) JP2001-216467

(51) Int. Cl. H04L 9/32

(52) U.S. Cl. 713/191

(57) ABSTRACT

The present invention is related to a control method for program and data installed in a computer to secure their security and reliability, and is also related to the computer that executes this method.

### TECHNICAL FIELD

The present invention is related to a control method for program and data installed in a computer to secure their security and reliability, and is also related to the computer that executes this method.

### BACKGROUND ART

In computer systems, there are various kinds of menaces to the security: information tapping, invasion to a system or a private network, pretension to the person in charge, data alteration, destruction of data or systems etc. To receive and send information, or to exchange information using computers connected to networks means to take risks for private networks or computer systems to give access to unspecified members of general persons. It also means to take risks for your information to be sent to unknown persons.

Computer system invaders steal data kept in computers, erase data, or rewrite data through networks. In some cases, there are cases that they destroy internal network systems themselves, or disturb computer-aided business. Further, they may use the invaded computers as their advanced bases to attack some communication networks.

To protect computers from these dangers, there are technologies: to use ID and passwords, to set up a firewall between a computer and a network, to cipher information, to use digital signatures, to use one-time passwords, to control access rights, etc.

### OBJECTS OF THE PRESENT INVENTION

Above-mentioned conventional technologies have the following problems:

(1) The technology to use ID and passwords is used for computers to judge users whether they are regular users or not. User names are used freely for address discrimination. And a password is used on the assumption that it is not known except the user himself. If an invader succeeds to steal a user name and his password, there will be a problem that the invader can freely access to the computer system as a regular user and can easily steal, alter, and erase data.

(2) A firewall watches the input and output of information between the inside and outside of a network. It plays the roll of checking the incoming and outgoing of information, and it also plays the role of selecting whether it is good or bad to pass. And a firewall has the function to record all access to be able to take actions when problems happen to occur. But a firewall itself is a computer connected to the internal LAN, and its treating speed affects the whole LAN system. So, the balance between its checking function and its treating speed must be the one worthy of practical use. Besides, it cannot prevent the virus etc. that have already invaded the computer system.

(3) Using ciphered keys, such as public or secret keys that have already developed, can protect information tapping effectively during their communication. But there are problems that management for the key not to be stolen is necessary and this method doesn't suit to data exchange with mutual persons of many members or with succeedingly changing members.

(4) A digital signature is also an advanced method of cipher technology, but the problem that doesn't suit to data exchange with mutual persons of many members or with succeedingly changing members remains still unsolved.

(5) One-time password is a password that can be used only once. As it is changed to another one at every access time, its security is higher than that of a general password, because it cannot be used at next or further access time even if it is stolen. But the use is limited, and there is a problem that the management of passwords is complicated.

(6) Method to control access rights is the one to make operating system have the function to inquire password at the time of access to a memory or others, and this has the same problem with the method to use user's name (ID) and passwords.

(7) Method to use virus checker or vaccine software to protect from a virus has the problem that it can only protect from the computer virus invasion that has been already known, and it may not protect from an unknown virus. That is, if it cannot discriminate a regular program from a virus program, it cannot protect from its infection.

### DISCLOSURE OF INVENTION

It is the object of the present invention to provide the following methods to solve above-mentioned problems:

(1) A control method of computer installation for application program to be attached with a discrimination code response module assigned with an unrepeated unique discrimination code, and to be operated on the above-mentioned computer with a discrimination code authentication module assigned with the same discrimination code with the above-mentioned discrimination code, and to be installed on the installer only when the coincidence of the two discrimination codes is confirmed by the communication between this discrimination code authentication module and the above-mentioned discrimination code response module.

(2) A control method for an optional data group to be downloaded, to be attached with a discrimination code module assigned with an unrepeated unique discrimination code, and to be operated on the computer to be downloaded with a discrimination code authentication module assigned with the same discrimination code with the above-mentioned discrimination code, and to be downloaded on the controller only when the coincidence of the two discrimination codes is confirmed by the communication between this discrimination code authentication module and the above-mentioned discrimination code response module.

(3) A computer with a discrimination code authentication module for the application program previously registered to permit to execute the commands of an application program only when the application program publishes the commands attached with the above-mentioned discrimination code previously registered on the computer.

(4) In the computer described in (3), the discrimination code authentication module renews the discrimination code registered corresponding to the application program to another discrimination code at optional timing.

(5) A computer provided with a data access control module that permits to access only the case that the access has an unrepeated unique discrimination code previously registered to that data.

(6) A control method of information treatment for a computer and a medium executing specified information treatment to be attached with a discrimination code response module assigned with an unrepeated unique discrimination code, for a discrimination code authentication module controlling the discrimination code corresponding to the above-mentioned medium to register on the computer to be operated on the computer when the above-mentioned medium is connected to the above-mentioned computer, and for the above-mentioned information treatment to be executed only when the coincidence of the two discrimination codes is confirmed by the communication between this discrimination code authentication module and the above-mentioned discrimination code response module.

(7) In the control method described in (6), the discrimination code response module to be renewed to the one assigned with another new unique discrimination code just after the end of the information treatment, and the new discrimination code to be registered on the computer as the one corresponding to the medium.

(8) An information installation method to a computer for a memory medium registered with the information to be installed in the computer to be registered with a response module that has the function to execute authentication, exchanging data for authentication, and on the computer to be installed with the above-mentioned information, to have an authentication module with the function to execute authentication exchanging data for authentication with the response module and an installer to install information registered on the above-mentioned medium when the authentication regularly finished, and at least for the above-mentioned authentication module to be downloaded from a supplier for authentication module distribution through network.

(9) In the information installation method described in (8), the computer is provided with a distribution request module that has the function to require authentication module distribution server to download the authentication module.

(10) In the information installation method described in (8), the server for authentication module is provided with a recording part for the distribution history data of the authentication module.

(11) In the information installation method described in (8), the authentication module is invalidated after the end of regular information installation to the computer.

(12) An authentication method for an automatic treating machine (ATM) that executes specified automatic trades using a card, for the card to have the first discrimination code generating module and the first discrimination code register that keeps the discrimination code generated from the first discrimination code generating module and inputs the first discrimination code generating module the discrimination code kept on the first discrimination code register at the next timing, and for the above-mentioned ATM that has the second discrimination code generating module to generate the second discrimination code from the inputted data converting in the same algorithm with the first discrimination code generating module and the second discrimination code register to keep the discrimination code outputted from this second discrimination code generating module, and for the ATM provided with an authentication module that authenticates whether or not the discrimination code generated from the above-mentioned first discrimination code generating module coincides with the one generated from the above-mentioned second discrimination code generating module.

(13) In the authentication method for the automatic treating machine (ATM) described in (12), the first discrimination code generating module receives a password inputted just before the authentication starts and the discrimination code registered on the first authentication register, generates a new (second) authentication code, and the above-mentioned second discrimination code generating module receives the password inputted just before the authentication starts and the discrimination code registered on the second discrimination code register, and generates a new authentication code.

(14) A computer program for a computer having a watching module to operate to send only the request from the application programs registered previously on a control table, and for the data writing on specified memory space through network interface connected to network, to be set up outside the control of the above-mentioned watching module.

### BRIEF DESCRIPTION OF DRAWINGS

FIG. 1 is a system block diagram to execute the control method of the present invention.

FIG. 2 is a sequence chart showing how the discrimination code response module 11 of an application program works together with installer 12 and discrimination code authentication module 13.

FIG. 3(a) explains a control method to raise the security of the system limiting the operation of the application program installed to a computer, and FIG. 3(b) is its operation flow chart.

FIG. 4(a) is a system block diagram to realize the control method to raise the security of the system, and FIG. 4(b) is its operation flow chart.

FIG. 5(a) is an explanation diagram of the above described control method applied for cash card system etc., and FIG. 5(b) is its operation flow chart.

FIG. 6 is a block diagram of another embodiment of the present invention.

FIG. 7 explains another control method of the embodiment that is different from the ones shown above, and its protection function for irregular copy of programs or data is more reinforced.

FIG. 8(a) (b) are the operation flow charts of the concrete method shown in FIG. 7. FIG. 8(a) shows how users receive authentication modules, and FIG. 8(b) shows the installation process.

FIG. 9(a), (b) are explanation diagrams showing another form of the present invention applied to e.g. bank cash card system. FIG. 9(a) is a main block diagram of card and ATM (Automatic Treating Machine) system, and FIG. 9(b) explains its operation.

FIG. 10 is the sequence chart of the system shown in FIG. 9.

FIG. 11(a) is a block diagram of another embodiment of the present invention used to a computer operating system, and FIG. 11(b) is an improved version of FIG. 11(a).

### EMBODIMENTS OF THE PRESENT INVENTION

The followings are the embodiments of the present invention.

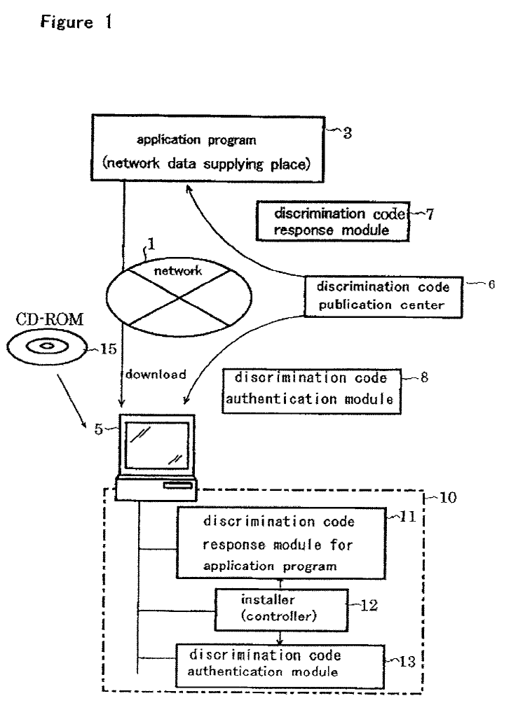

FIG. 1 is the system block diagram of a control method to execute the program or data of the present invention.

To network 1 in this figure, a computer for application programs or network distribution data supplier 3, or servers is connected. Terminal 5 for an optional client is also connected to the network 1. This terminal 5 is either of a personal computer, or a mobile computer, or another optional computer of various kinds. Network 1 may be anyone that can redirect data or programs; e.g. an internet network or an intranet network. In a system like this, terminal 5 can get application programs or network distribution data through network 1.

But, by using a system like this, it can be possible to redirect the downloaded application programs or network distribution data to another terminal as they are, and use them there irregularly. That is, if application programs or data are distributed through network 1 in the condition that they can be used as they are, there is a problem that it is difficult for the suppliers to secure the copyrights.

This invention inhibits application programs and data, downloaded to terminal 5, to be used as they are, or to be downloaded without regular permission. For this purpose, discrimination code publication center 6 is provided, for example. This discrimination code publication center 6 assigns an unrepeated unique discrimination code to every application program supplied from application program supplier 3. And the center supplies to the application program supplier 3, the discrimination response code module 7 that responses to the discrimination code as its key.

This discrimination code response module 7 is built in the application program. For example, when the discrimination code response module 7 is inquired with the asking command with assigned discrimination code, it answers “GOOD”, but in any other case, it responses with the output meaning “NG”. The discrimination code response module 7 may be any form having the function that expresses the assigned discrimination code, but it is more effective for irregular copy that the discrimination code is not outputted from application program side.

Moreover, when client's terminal 5 requires application program to be downloaded, the discrimination code publication center 6 supplies discrimination code authentication module assigned with the same above mentioned discrimination code. For example, a client previously contracts purchase contraction for an application program and gets the right for getting the discrimination code authentication module. The discrimination code publication center 6 sends a discrimination code authentication module 8 to terminal 5 through network 1. This discrimination code authentication module 8 is registered in the specified register space of terminal 5, and when the downloaded application program is installed, the module executes authentication that will be described later.

Besides sending directly from discrimination code center 6 to terminal 5 through network 1, there are other ways to send discrimination code authentication module 8 to terminal 5. For example, application program supplier 3 sends directly the discrimination code authentication module 8, supplied from discrimination code publication center 6. But in this case, the effect that discrimination code authentication module 8 is prepared and sent separately from application program will be small, except that the discrimination code authentication module 8 is sent in another different way and with another different timing from application program. Otherwise, if the application program and the discrimination code authentication module 8 are copied at the same time, irregular copy will be possible. Accordingly, it is desirable to download discrimination code authentication module 8 to client's terminal 5 without the information to the client, at the contract time of application program purchase for instance.

In the example described above, the example that an application program was downloaded to clients' terminals through network 1 was explained. And the same operation can be executed with the case that the application program is registered on a medium like CD-ROM 15. In this case, the discrimination authentication module 8 must be always sent to terminal 5 on quite a different route.

When an application program is downloaded to terminal 5 and begins to be installed, a program and modules shown in the area surrounded by a dot and a dash line 10 in FIG. 1 begin to start on terminal 5. The discrimination code response module for application program 11 is the discrimination code response module for the application program downloaded. Installer 12 is a program for control to start the application program installation and to make it possible to be used. Discrimination code authentication module 13 is a program module supplied from discrimination code publication center 6 to terminal 5.

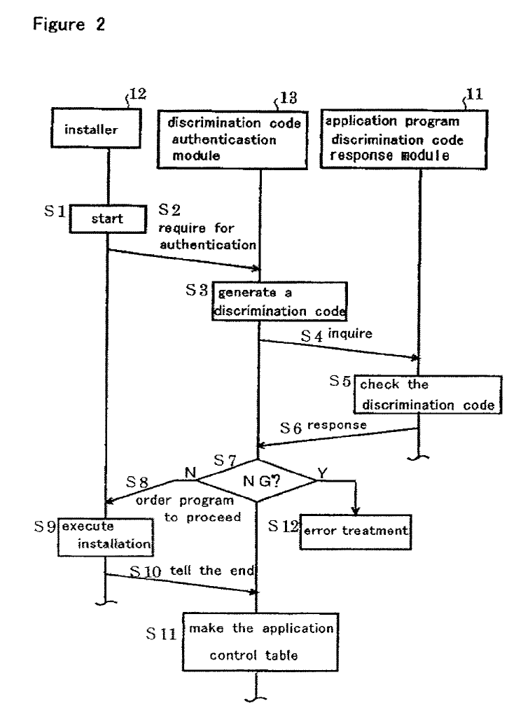

FIG. 2 is a sequence chart showing the operation of discrimination response code module for application program 11, installer 12, and discrimination code authentication module 13 described above.

It is supposed that, before the start of this sequence, the application program is downloaded to terminal 5 previously and discrimination code authentication module 8 is registered on the specified memory space. Now, installer 12 begins to start application program (step S1). At this time, installer 12 requires discrimination code authentication module 13 to authenticate the downloaded application program (step S2). At step S3, discrimination code authentication module 13 generates discrimination code for authentication (step S3). This discrimination code is same with the one assigned to discrimination code response module 7 for the application program that has downloaded from network 1.

Discrimination code authentication module 13 sends inquiry command attached with the generated discrimination code to discrimination code response module 11 (step S4). Discrimination code response module 11 checks this discrimination code (step S5). When it is checked that the inquiry command has the same discrimination code with the one assigned to itself, it responses that the discrimination code coincides. In the other case, it responses that the discrimination code does not coincide. Receiving this response (step S6), in case of coincide, discrimination code authentication module 13 steps to S7 and S8, and indicates the installer 12 to continue installation. In other cases, error treatment is executed at step S12

When indication to continue installation is sent from discrimination code authentication module 13 to installer 12, the installation of the downloaded program is executed at installer 12 (step S9). Installation of the program is completed in this way. When installation of the program is completed, installer 12 sends the notice of the completion to the discrimination code authentication module 13 (step S10). The discrimination code authentication module 13 makes an application control table to watch the execution of the program hereafter (step 11). This application control table is registered on the specified non-volatile memory in terminal 5 in FIG. 1, and when the application program is operated, the table is used to control the operation, in the way that will be explained later.

According to the method described above, if the application program downloaded from application program supplier 3 to terminal 5 in FIG. 1 is copied to another computer, it cannot be installed and set up, because discrimination code authentication module does not work. That is, irregular copy can be prevented because the installation cannot be executed except for the clients who have formally purchased it. To say more, the control method described above is not limited for application programs only. The same methods can be applied to various kinds of data distributed through networks, such as music data and book data. It is needless to say that the same method can be applied with the data distributed by other media, such as a floppy disk, a CD-ROM, and a memory card. These data are previously inserted with specified discrimination code response modules, and distributed. A discrimination code authentication module 8, having the right to use those data, is supplied by another different route to e.g. the paid client's terminal. With this method, it is possible to prevent application program from irregular copy.

Now let us consider the case of CD-ROM distribution through direct mail or sale as a supplement to a magazine. On this CD-ROM, data, such as program, data, and various kinds of books are registered, and the specified discrimination code is assigned to each of these data. These data are not open to be used without installation. The situation is same with that of the application program or data downloaded on terminal 5 in FIG. 1. Here, a user at the client terminal 5 tells application program supplier 3 the information concerning the desirable part of the CD-ROM such as the serial number and the name of the program through network 1. After the fee is paid, the supplier checks the discrimination code assigned to the application program registered on the CD-ROM, based on the serial number of the CD-ROM, and sends the corresponding discrimination code authentication module to the client at terminal 5.

So doing, the process shown in FIG. 2 can be possible. Moreover, in the example described above, the control to use programs or data copied or downloaded on a computer with discrimination codes was explained. And the same control, or the computer control with discrimination codes, may be used to control copy or download programs or data on a computer.

The discrimination code described above can be published from application program supplier, not from discrimination code publication center. But it is essential to secure the security of this system in any place and in any surroundings not to use unrepeated discrimination code. Accordingly, it is better to set up discrimination code publication center 6 and all application program suppliers, such as music distribution companies, etc. ask the center 6 to publish discrimination codes. With this method, it is possible to publish unique discrimination codes continuously, and high security can be obtained.

To say more, irregular copy can be possible if discrimination code authentication module 8 is picked up from a computer and copied with the downloaded application program. So, a method may be adopted, for example; that the discrimination code authentication module is deleted by installer 12 after one installation. With this method, it is possible to limit the installation only once for all. Concerning the restoration of the application program, supplier's support through network will be sufficient.

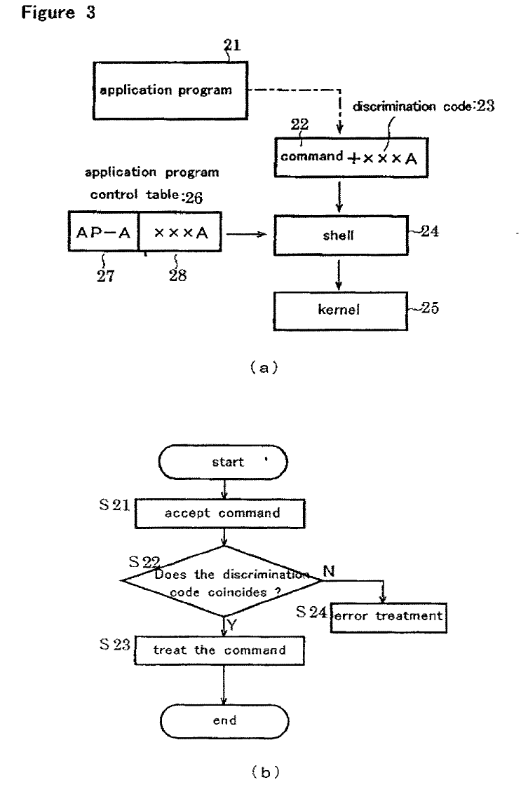

FIG. 3(a) explains how to control the operation of the application program installed on a computer to raise the security of the system, and FIG. 3(b) is its operation flow chart.

After the application program is installed at step S9 in FIG. 2 and the end of installation is told to the discrimination code authentication module 13 at step S10, the authentication module 13 makes an application control table on the computer at step S11. As shown in FIG. 3, the application control table corresponds the application name 27 and its discrimination code 28. This discrimination code 28 may be quite different from the one used for the installation. In this example, the application program 21 that has been installed attaches always at every action a certain discrimination code 23 to the command 22 that is published to operate. When the command 22 is sent to OS (Operation System), it is interpreted at shell 24 at first, and the result of the interpretation is redirected to kernel 25.

When the command 22 is analyzed, this shell 24 judges from which application program the command comes. At the same time, the attached discrimination code is picked up. And referring the application control table 26, shell 24 checks where the command and the discrimination code come from. Command 22 is interpreted at shell 24 only in the case when application program 21 publishes command 22 attaching the discrimination code 28 registered on the application control table, and redirects it to kernel 25. An application program, installed irregularly, is not registered on the application control table. Besides, commands invaded from networks etc. have no necessary discrimination code attached to them. Accordingly, these commands cannot be executed, because the commands are refused to be treated by shell 24, and are not redirected to OS. That is, the environment where any application program does not work without specified registration can be set up. Therefore, extremely high safety system can be obtained.

Let us explain definitely the interpretation operation of commands using FIG. 3(b). First, at step S21 shell 24 receives a command from any application program. At step S22, referring application control table 26, shell 24 judges whether or not the discrimination code 23, attached to command 22, coincides with discrimination code 28 of registered application program 21. If it coincides, flow goes to step S23 and the command is executed. If it does not coincide, flow goes to step S24, error treatment is executed and the command is rejected. To say more, in this example it is better for all commands to be received by shell 24 only and interpreted by shell 24 only. With this, extremely high safety computer system can be obtained.

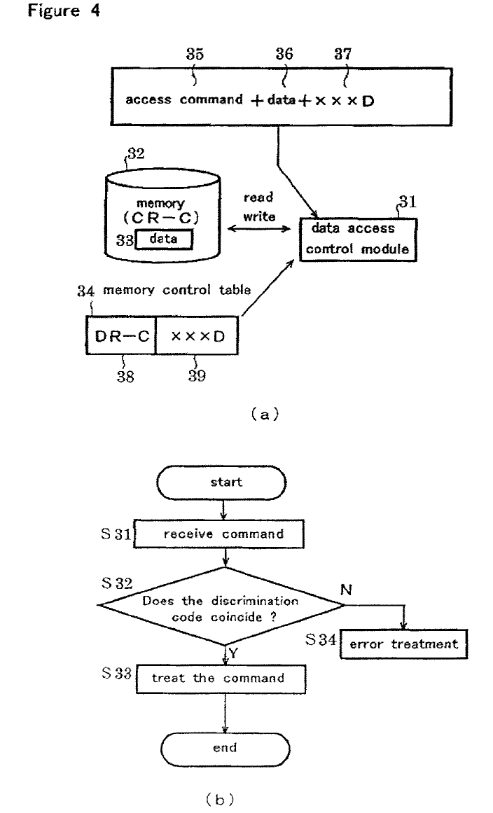

FIG. 4(a) is a system block diagram showing the control method to obtain high security for data access, and (b) is its operation flow chart.

In this embodiment, the discrimination code described above is used for all memories used in a computer, or a memory space that need protection, for instance, data access to a special drive. As FIG. 4(a) shows, data access control module 31 controls access to data 33 registered in memory 32, or to other data registered in memory 32. For this purpose, a memory control table is used. Data used for access consists from access command 35, data 36, and discrimination code 37, as shown in FIG. 4(a). In the memory control table 34, e.g. drive name 38 to which access is controlled and its discrimination code 39 are registered in pair. In this embodiment, data cannot be read or written except the case when the data attached with the corresponding discrimination code.

When access command 35, data 36, and discrimination code 37 are inputted to access control module 31, the command is first received at step S31, as shown in FIG. 4(b). At step S32, data access control module 31 refers them to memory control table 34. And if the destination of the access is judged to be drive 38, registered discrimination code 39 and discrimination code 37 attached to data 36 are compared and judged whether they coincide or not (step S32). If they coincide, the access command is permitted to execute and other commands, such as data writing command, are permitted (step S33). On the other hand, if the two discrimination codes do not coincide, flow goes to step S30, and error treatment is executed. That is, access to data cannot be received. This data access control module 31 may be either a part of a function module included in the shell explained in FIG. 3, or a program module set up quite independently.

If it is done as described above, the data having no discrimination code attached to them cannot access to the corresponding drive, cannot read, nor write the data on the corresponding drive. So if the discrimination code is strictly controlled, the access to drive 2 is completely limited for only the application program attached with the corresponding discrimination code. Accordingly, quite high security system can be obtained free from the fear, for instance, that computer invading data through network might write in the memory without notice.

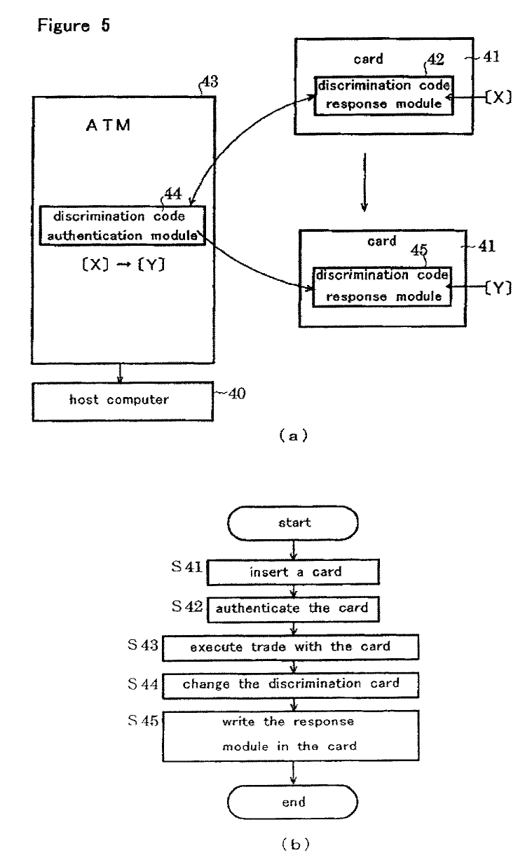

FIG. 5(a) shows a cashing card system using above-mentioned control system, and FIG. 5(b) is its operation flow chart.

Card 41 in FIG. 5 is a so-called IC card, i.e. a memory built-in cash card or a memory built-in credit card. In its memory, the discrimination code response module 42, assigned in the way described above, is registered. In ATM (Automatic Treating Machine) 43, discrimination code authentication module 44, described above, is registered.

This ATM 43 is a well-known machine of bank, used at the time of deposit and payment of checking account. Many ATMs, not described here except ATM 43, are also connected to a host computer that controls money system. In the case of credit card, a credit card reading machine plays the role of ATM. When card 41 is inserted in ATM 43, authentication is executed according to the specified order, and after that, cash deposit or payment is executed according to the well-known order. At that time, above-mentioned authentication between discrimination code response module 42 and discrimination code authentication module 44 is executed. First, when card 41 is inserted in ATM 43 (step S41), user name, account number, etc. are read automatically. At ATM 43 side, the ATM refers these data to host computer 40, and gets user's information with the discrimination code.

Discrimination code authentication module 44 outputs asking command concerning the discrimination code and asks discrimination code response module 42 of card 41 for its discrimination code. If the discrimination code coincides, the card is judged correct, and authentication is over (step S42). And trade with the card is executed (step S43). The basic process of this treatment is same with the one already explained in FIG. 1. If card 41 has these functions, user's discrimination code cannot be stolen, even if the card is investigated, because the discrimination code response module 42 itself does not generate a discrimination code.

Besides, in this embodiment, the discrimination code is controlled to be changed at every using time according to the following process: after card 41 is inserted in ATM 43 and 1^{st} trade is finished, ATM 43 writes another different discrimination code on card 41. That is, instead of the last discrimination code response module, another different discrimination code response module is registered in card 41 (steps S44, S45). Let us assume that a discrimination code X is assigned to the last discrimination code response nodule 42. In this case, after trade is over, another different discrimination code response module 45 whose discrimination code is another different code Y is registered. At ATM 43 side the information that the discrimination code X is changed to Y is registered. That is, when card 41 is used at ATM next time, authentication will be executed with the new discrimination code Y.

As described above, because no data to read out discrimination code are registered in card 41, the card cannot be forged unless the card is copied completely. For example, discrimination code response module 42 is the computer program that outputs yes or no, judging whether its assigned discrimination code coincides with the one attached to the asking command or not, when it receives the command. Accordingly, this system has the merit that it is possible to secure strictly the secret of discrimination code, because the discrimination code cannot be read directly by simply analyzing its data from outside. Besides, if the system that the discrimination code is changed at every trade is adopted, the discrimination code cannot be used, even if the discrimination code response module 42 of card 41 is copied to another card and tried to operate ATM. Therefore, irregularly copied card is completely useless. That makes it possible to protect completely to use a stolen code number or to use an irregularly copied card.

If the control method that a new discrimination code is assigned at every trade and old discrimination code becomes invalid is adopted, it is necessary to set up a center to generate unrepeated unique discrimination codes. Needless to say that it need not necessarily one and only discrimination code, because it is used with the user's user code combined together. It may be unique in the country, or in the region for instance. Or, the discrimination code may be such as generated in the manner that the same one does not appear for about 10 years. In the case of money system, the discrimination code publication center is set up in host computer 40, and it is desirable for host computer 40 to publish unique discrimination codes to all ATMs controlled by host computer 40. It is also desirable for host computer 40 to control always which user uses which discrimination code and executes trade in response to the changing discrimination code.

To attach a discrimination code to a command shown in FIG. 3 or 4, a method shown in FIG. 5 may be adopted. The discrimination code used at the time when the application program started, is changed to another new one after the end of the operation, for instance. At the same time application control table is also re-written. The discrimination code used at the access time is also renewed after a series of access operation is completed. The memory control table is also re-written, at the same time. If the discrimination code authentication module, that generates a discrimination code response module, always controls the operation of application programs and data access, and renews the discrimination codes timely, very high security control of programs and data can be possible.

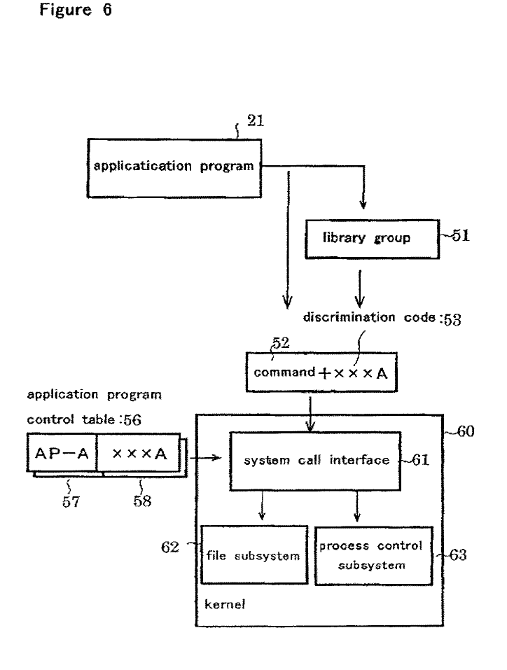

FIG. 6 is a block diagram of another form of this invention.

In the embodiment described in FIG. 3, shell 24 refers the application control table and protects the operation system by refusing to interpret commands without registered discrimination codes. In the embodiment shown in FIG. 6, the kernel has this function. In FIG. 6, system call interface 61 of UNIX operation system refers application control table 56. Namely, system call interface 61 receives commands attached with discrimination code come from application program 21 or library group 51. System call interface 61 refers them to application control table 56. Application control table 56 is a group of pairs that are registered a name 57 of application program 21 or library group 51 and its discrimination code in correspondence with each other. When system call interface 61 finds that the discrimination code comes from application program 21 or library group 51, system call interface 61 sends the commands to file subsystem 62 or process control subsystem 63. In any other case, error treatment is executed. With this method same control as described in FIG. 3 can be made. In either case of FIG. 3 or FIG. 6, it is possible to prevent irregular commands from invading the operating system before they reaches the operating system, by checking the discrimination code. Namely, if you secure the means how the regularity of commands is checked with the discrimination codes attached to it in any place in a computer, you can stop completely the invasion of irregular commands to the operating system. Of course you can attach discrimination codes only to the commands that have important functions, and reduce the computer load to check discrimination codes.

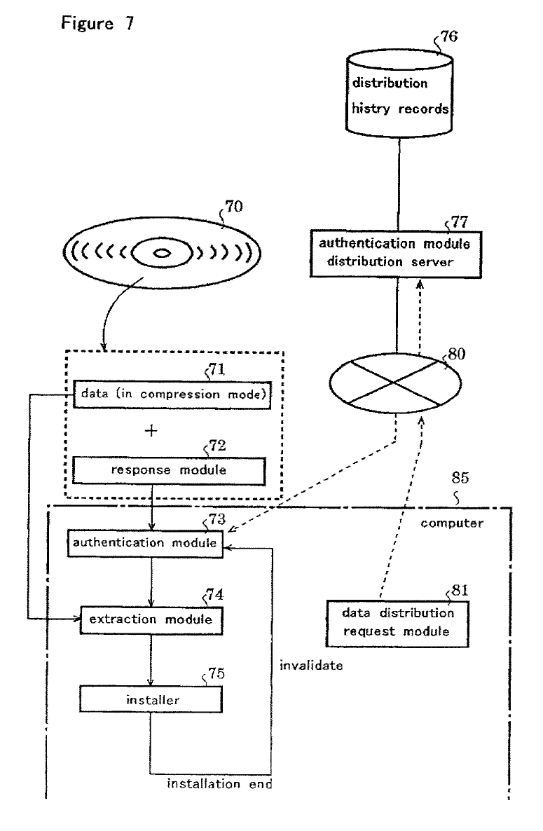

FIG. 7 shows another embodiment that protects more strongly from irregular copy of programs or data.

CD-ROM 70 in FIG. 7 is a registered medium containing data such as computer programs, music, etc. It is a registered medium containing information that is going to install to a computer. This system prevents these data from irregular copy at the time of download or installation to computer 85. For this purpose, response module 72 is registered in addition to data 71. Data 71 are music data or computer program data etc. stored in a well-known compression form. Response module 72 is a computer program that has communication functions of authentication data, etc. with authentication module 73. The authentication process has already explained.

At computer side authentication module 73, extraction module 74, and installer 75 are ready to operate. Extraction module 74 is the program that has the function to extract compressed data 71. Installer 75 is the program that executes well-known installation function to send the extracted data to the specified position by computer 85 and to register them there. Authentication module 73 is downloaded to computer 85 through network 80. And distribution request module 81 is attached to computer 85. Distribution request module 81 is the computer program that requires the authentication module distribution server 77 to download authentication module in an interactive way, for example. And authentication module distribution server 77, connected to computer 80, has distribution history recording part 76, that records information such as when and what kind of authentication module has been sent to whom. Distribution history recording part 76 consists from memory connected to authentication module distribution server 77, etc.

In this system, users cannot install computer programs or data to computer 85, with only CD-ROM on the market or distributed in various methods. Users must contract previously a certain contract to get distribution demand module 71 and operate it to demand authentication module 73 from authentication module distribution server 77. The distributed authentication module controls data 71 on CD-ROM 70 to be installed to computer 85.

In this embodiment, authentication module 70 is quickly invalidated after the installation of data 71 is over. That is, this process makes the authentication module to be used only once for each installation. With this process, it is prevented to copy irregularly the data registered on CD-ROM 70 with stolen authentication module 73. To say more, some relief system is necessary to re-distribute authentication module 73 to regular user, when some trouble happened to occur after the installation, and regular re-installation to the user becomes necessary. So, distribution request module 81 is left in computer 85, and it is possible to require authentication module distribution server 77 to distribute the module at any time. In this case, distribution history of authentication module 73 is registered in distribution history recording part 76. This distribution history record has the function to restrain irregular usage. As the persons who can require authentication module 73 are limited within the contracted users only, the users have clear responsibility for the installation place, the installed data management, and the installation operation. Accordingly, there is not such trouble that, without the knowledge of regular user, CD-ROM is irregularly copied, and the data or the computer programs are installed irregularly.

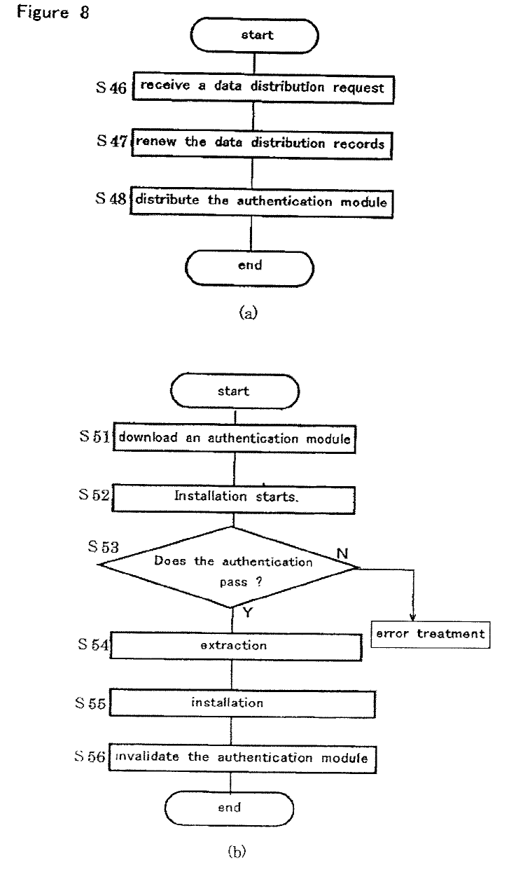

FIG. 8 shows the operation flow chart of the system process shown in FIG. 7.

As shown in FIG. 8(a), a user is distributed with the authentication module. As distribution demand module 81 starts at step S46, authentication module distribution server 77 receives a data distribution request. Next, at step S47, the records of distribution history recording part 76 are renewed. And at step S48, authentication module distribution server 77 distributes authentication module 73 to user's terminal through network 80. As authentication module 73 is ready to start on user's terminal in this way, installation process described in FIG. 8(b) is executed.

First at step S51 an authentication module is downloaded, and at step S52 installation starts. Response module 72 corresponding to CD-ROM 70 is redirected to computer 85 and starts to execute authentication exchanging code data etc. with authentication module 73. If the authentication does not pass, an error signal is generated. If the authentication passes, flow goes to step S54. And extraction module 74 extracts the data registered on CD-ROM. At step S55 installer 75 executes installation. After the installation is regularly completed, the authentication module 73 is invalidated at step S56. The method to invalidate authentication module 73 is free. You can use the method to delete the authentication module 73 itself, or other methods such as to delete the parameter that makes authentication module 73 to work.

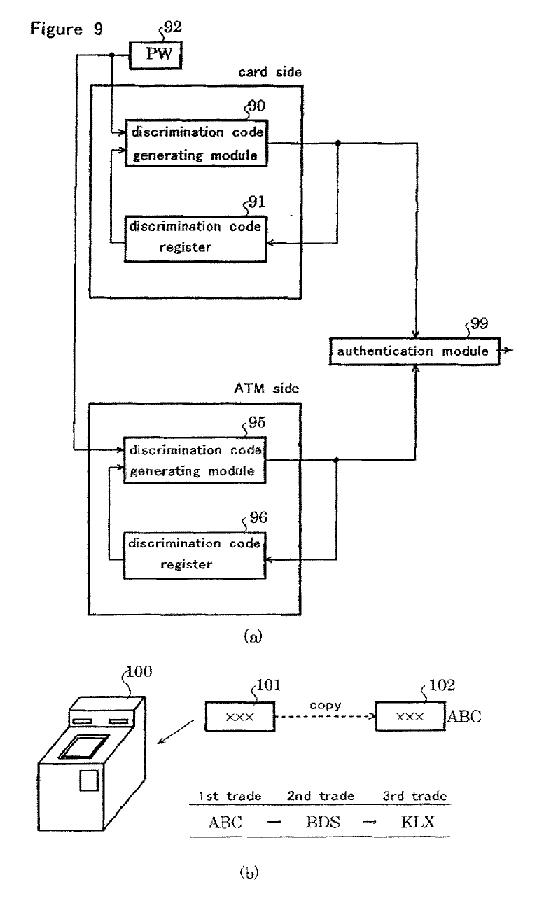

FIG. 9 shows another embodiment, according to the present invention, applied to bank cash card system. FIG. 9(a) is the main block diagram of card and ATM (Automatic Treating Machine) system, and FIG. 9(b) is the explanation diagram of its operation.

As shown in FIG. 9(a), discrimination code generating module 90 and discrimination code register 91 are provided at card side. Discrimination code generating module 90 is the computer program that operates in the computer on the card. Discrimination code register 91 is provided in the register area of the card. At ATM side discrimination code generating module 95 and discrimination code register 96 are also provided. Discrimination code generating module 95 is the computer program that operates in the computer in the ATM, and discrimination code register 96 is provided in the register area of the ATM.

When a password 92 is inputted at card side, immediately before authentication operation, discrimination code generating module 90 reads out discrimination code registered in discrimination code register 91, before authentication module 99 begins to operate. At ATM side, discrimination code generating module 95 has the same function and generates new discrimination code using discrimination code register 96, after password 92 is inputted. Discrimination code generating module 90 and discrimination code generating module 95 have quite the same function, and generate same new discrimination codes at both card side and ATM side, when same password and same discrimination code are inputted. So, when a user inserts his card and inputs password 92 into ATM, as shown in this figure, new discrimination codes are generated at both card side and ATM side. At this time, same discrimination code is obtained at both card side and ATM side. These codes are compared with each other with authentication module 99, and the authentication is executed. That is, in the case that the discrimination code, generated by discrimination code generating module 90 at card side, coincides with the discrimination code generated by discrimination code generating module 95 at ATM side, it is judged that the authentication is correctly operated, and cash trade etc. are executed after that. In all other cases, error treatment is executed.

In this embodiment, the following very important effect is obtained.

First, the discrimination code for the next trade is nowhere registered at either card side or ATM side, even though the discrimination code used at the last trade is registered in discrimination code register 91 at card side and in discrimination code register 96 at ATM side. At next trade, new discrimination codes generated using the discrimination codes registered in discrimination code register 91 and 96, together with the password inputted from user are used for authentication. For this reason, even if the third person who has stolen the information registered on the card, for example, tried to execute irregular trade with the discrimination code registered in discrimination code register 91, ATM does not operate. The discrimination code necessary for trade cannot be obtained till the time when discrimination code generating module 90 operates in practice.

Besides, because quite a new different discrimination code is generated and used at every time the card is used, i.e. at every authentication, the third person cannot use the directly copied discrimination code. More reliable security can be obtained if the password inputted by a user becomes necessary for generating a new discrimination code, as well as the discrimination code generated just before the authentication. To say more, as shown in FIG. 9(b), let us assume that the third person has made a completely same card that has the same construction with the card 101, and that the discrimination code is copied from 101 to 102. At this condition, if the user's password was also stolen, and the copied card and the stolen password were used at the same time immediately after the steal, effective trade can be executed with the card.

But when the regal user operates ATM 100, using card 101, the discrimination code registered in the discrimination code register 91, and 96 will be changed at that time. That is, the discrimination code varies one after another at 1^{st} trade, 2^{nd} trade, 3^{rd} trade and so on. So, even if the third person who has irregularly obtained the discrimination code tried to use card 102, the discrimination code has already been changed at that time and card 102 cannot be used. As described here, not only the changing operation at every trade, but also the setting of the discrimination code generating modules at both card side and ATM side, and authentication for the new discrimination code generated at every trial make the trade security extremely high.

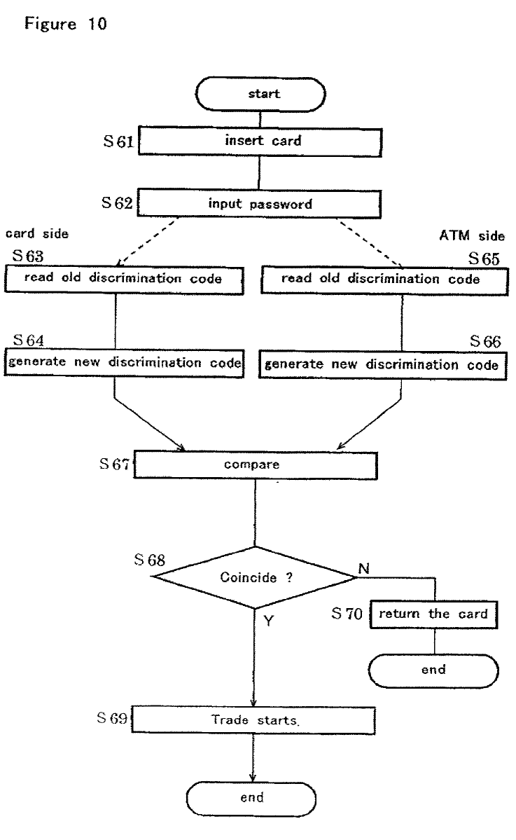

FIG. 10 is the flow chart to explain the operation of ATM using the cards shown in FIG. 9.

First, at step S61, card 101 is inserted into ATM 100, and at step S62, password 92 is required to be inputted. As password 92 is inputted, each discrimination code generating module starts to work separately, at card side and at ATM side. At card side the old discrimination code is read at step S63, and at step S64, a new discrimination code is generated. At ATM side the old discrimination code is also read at step S65, and the new discrimination code is also generated at step S66. After that, the discrimination codes generated at card side and the one generated at ATM side are compared. The comparison is executed by authentication module 99 operating in the ATM. If the two discrimination codes are judged to coincide at step S68, flow goes to S69 and trade starts. On the other hand, if not coincide, card is returned and error treatment is executed (step S70).

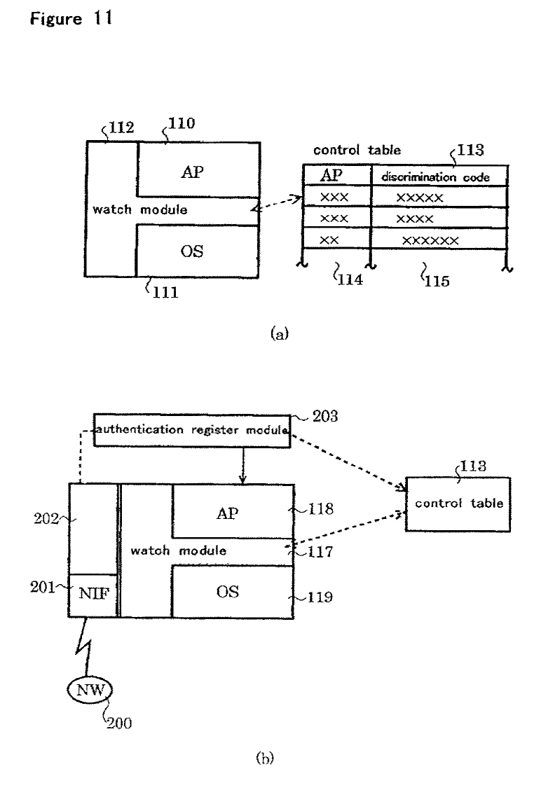

FIG. 11 is a block diagram showing another form of operation system in a computer using the method of the present invention.

As explained before, you can inhibit an unregistered application program to work on operating system 111, if you install any application program 110 in the operating system 111 of a computer, and prepare control table 113 and register the discrimination code 115 corresponding to application program 114. Namely, you hand only command of the regularly registered application program to the operating system 111. With this, treatments such as writing command etc. of the application programs that have no control from the operating system 111 are excluded; and normal operation of the computer is maintained. Besides, irregular access from outsides and irregular actions of computer virus are also excluded.

A strict control like this is not used except for limited applications. It suits for bank systems, for instance. But it does not suit for an environment like personal computer that accesses various kinds of data connected to internet and uses their application program safely. A system shown in FIG. 11(b) is an improved version of a system shown in FIG. 11(a). As shown in FIG. 11(b), watching module 117 stands between application 118 and operating system 119. But network interface function 201 connected to network 200 stands outside the watch of the watching module 117. And the memory space 202 is set up where network interface 201 can write in freely. To say more, it may be permitted to limit the memory space where network interface can write in, to prevent irregular data or irregular program from writing in anywhere of the memory space.

As explained above, a certain space 202 where watching module does not control is remained for the treatment of network 200 connection. Accordingly, for instance, there is no limitation for temporary file that registers browser and its history, or application operations that operate on HTML protocol. On the other hand, when you want to download data or application programs through network 200 and to operate them through the operating system 119, the authentication registration module 203 picks up necessary data from the memory space 202, and registers them on the control table 113. With this embodiment, the environment is set up where you can communicate freely with network, pick up data from network, and download application program freely from network.

Each block shown in FIGS. 11(a) and (b) may be either a separated group form of each program module or a unit form of one program module. To say more, all or parts of these program modules may be made from hardware of logical circuits. Each module may be built in an existing application program, or may be an independent program that works separately. The computer program to realize the present invention may be registered on a medium such as a CD-ROM that can be read by a computer, and from that medium the application program is installed to a computer to use them. They can be also downloaded through network to computer memory to be used.

What is claimed is:

1. A control method of computer installation for an application program to be attached with a discrimination code response module assigned with an unrepeated unique discrimination code,
and to be operated on said computer with the discrimination code authentication module assigned with the same discrimination code with said discrimination code,
and to be installed on an installer only when the coincidence of the two discrimination codes is confirmed by the communication between this discrimination code authentication module and said discrimination code response module.

2. A control method for an optional data group to be downloaded, to be attached with a discrimination code module assigned with an unrepeated unique discrimination code,
and to be operated on a computer to be downloaded with the discrimination code authentication module assigned with the same discrimination code with said discrimination code,
and to be downloaded on a controller only when the coincidence of the two discrimination codes is confirmed by the communication between this discrimination code authentication module and said discrimination code response module.

3. A computer with a discrimination code authentication module for an application program previously registered to permit to execute the commands of said application program only when said application program publishes the commands attached with said discrimination code previously registered on said computer.

4. The computer of claim 3, wherein the discrimination code authentication module renews the discrimination code registered corresponding to the application program to another discrimination code at optional timing.

5. A computer provided with a data access control module that permits to access only the case when the access has an unrepeated unique discrimination code previously registered to that data.

6. A control method of information treatment for a computer and a medium executing the specified information treatment to be attached with a discrimination code response module assigned with an unrepeated unique discrimination code,
for a discrimination code authentication module controlling the discrimination code corresponding to said medium to register on the computer to be operated on said computer when said medium is connected to said computer,
and for said information treatment to be executed only when the coincidence of the two discrimination codes is confirmed by the communication between said discrimination code authentication module and said discrimination code response module.

7. The control method of claim 6, wherein the discrimination code response module to be renewed to the one assigned with another new unique discrimination code just after the end of the information treatment, and the new discrimination code to be registered on the computer as the one corresponding to the medium.

8. An information installation method to a computer for a memory medium registered with the information to be installed to the computer to be registered with a response module that has the function to execute authentication exchanging data for authentication to be registered on,
and on said computer to be installed with said information, to have an authentication module with the function to execute authentication exchanging data for authentication with said response module and an installer to install information registered on said medium when the authentication regularly finished,
and at least for said authentication module to be downloaded from a supplier for authentication module distribution through network.

9. The method of claim 8, wherein the computer is provided with a distribution request module that has the function to require authentication module distribution server to download the authentication module.

10. The method of claim 8, wherein the server for authentication module is provided with a recording part for the distribution history data of the authentication module.

11. The method of claim 8, wherein the authentication module is invalidated after the end of regular information installation to the computer.

12. An authentication method for an automatic treating machine that executes specified automatic trades using card,
for the card to have the first discrimination code generating module and the first discrimination code register that keeps the discrimination code generated from the first discrimination code generating module and inputs the first discrimination code generating module the discrimination code kept on the first discrimination code register at the next timing,
and for said automatic treating machine that has the second discrimination code generating module to generate the second discrimination code from the inputted data converting in the same algorithm with the first discrimination code generating module and the second discrimination code register to keep the discrimination code outputted from this second discrimination code generating module,
and for said automatic treating machine provided with an authentication module that authenticates whether or not the discrimination code generated from said first discrimination code generating module coincides with the one generated from said second discrimination code generating module.

13. The method of claim 12, wherein the first discrimination code generating module receives a password inputted just before the authentication starts and the discrimination code registered on the first authentication register, generates a new authentication code, and said second discrimination code generating module receives the password inputted just before the authentication starts and the discrimination code registered on the second discrimination code register, and generates a new authentication code.

14. A computer program for a computer having a watching module to operate to send only the request from the application programs registered previously on a control table, and for the data writing on specified memory space through network interface connected to network, to be set up outside the control of said watching module.
